(19) United States
(12) Patent Application Publication
(10) Pub. No.: US 2025/0001587 A1
(43) Pub. Date: Jan. 2, 2025

(54) A MULTI-AXIS ROBOT

(71) Applicant: VICTREX MANUFACTURING LIMITED, Thornton Cleveleys, Lancashire (GB)

(72) Inventors: Joseph Elmquist, Grantsburg, WI (US); Stephen Dougherty, Thornton Cleveleys, Lancashire (GB); Andrew Anderson, Thornton Cleveleys, Lancashire (GB)

(21) Appl. No.: 18/689,355

(22) PCT Filed: Sep. 6, 2022
(86) PCT No.: PCT/US2022/075977

§ 371 Date: Mar. 5, 2024

(30) Foreign Application Priority Data
Sep. 6, 2021 (GB) 2112659.4

(51) Int. Cl. B25J 9/00; B25J 9/10

(52) U.S. Cl. CPC B25J 9/0012; B25J 9/102

(57) ABSTRACT

The invention relates to a multi-axis robot (100) comprising a plurality of gearboxes, wherein each of the plurality of gearboxes is configured to operate on a respective robot axis (A1-A6) and comprises one or more gears formed of a plastics material. The invention also relates to a gearbox for use in a robot (100) and the use of a gearbox in a robot (100) and robot subsystems.

This invention relates generally to robots, e.g. articulated robots. More specifically, although not exclusively, this invention relates to multi-axis robots, e.g. multi-axis articulated robots, having a plurality of gearboxes, a gearbox for use in a robot, the use of a gearbox in a robot and robot subsystems.

Collaborative robots (cobots), are robots intended for direct human-robot cooperation within a shared workspace or are intended to operate where humans and robots may be in close proximity. These often take the form of robotic arms having two or more joints and an end effector.

As a result of the interactions between humans and cobots, and their close proximity during operation, safety of cobots is of primary concern. To ensure human safety during cobot operation, certain measures and safeguards must be placed on the cobot and/or implemented in the workspace, for example as agreed and outlined in the industry standard ISO TS 15066. These measures include:
A safety stop wherein the cobot stops operation while a human is within the operational area;
Separation and speed management wherein the cobot ensures a safe physical separation from all humans in dependence on the environment, and is able to react to a changing environment and prevent collisions safely;
Power and force limiting wherein the cobot ensures all operational forces are below a predetermined threshold that can cause bodily harm to a human.

Therefore, to ensure safety, cobots must be able to respond in the event of contact with a human. It is also advantageous if the cobot is responsive during non-contact events, such that operation may be optimised. The potential for injury to a human during a contact event between a human and cobot can be mitigated by stopping the cobot before it moves far enough to generate an impact sufficient to cause injury, with body force limits being set-out in the aforementioned ISO TS 15066. Therefore, it has been determined that increasing the responsiveness of cobots reduces the likelihood of injury.

It has also been determined that cobot stopping distance, stopping time, stopping force, and collision force are all proportionally related to the momentum generated by the cobot weight and payload, and speed profile. Therefore, for a given set of control and sensing capabilities, the cobot safe operation can most significantly be improved through:
A reduction in payload capacity;
A reduction in cobot weight and inertia;
Restrictions placed on cobot speed.

Since payload capacity and cobot speed are imperative to the operational efficiency of the cobot, it would be advantageous to reduce the cobot weight and inertia, thereby increasing responsiveness, while maintaining or even improving payload and speed capacities.

The present Applicants have found that the responsiveness of a cobot can be improved through the use of lightweight materials in the gearbox, resulting in a reduction of the overall weight of the device, and inertia of each of the joints. Furthermore, it has also been found that the gearbox strength to weight ratio with gears made of fibre reinforced plastic materials is particularly advantageous in the case of low payload, high reach cobots.

It is therefore a first non-exclusive object of the invention to provide an improved robot, and in particular, a cobot. It is a further, non-exclusive object of the invention to provide a safer, more productive robot.

Accordingly, a first aspect of the invention provides a multi-axis robot comprising a plurality of gearboxes, wherein each of the plurality of gearboxes is configured to operate on a respective robot axis and comprises one or more gears formed of a plastics material.

It has been found that by providing one or more gears formed of a plastics material, the resulting multi-axis robot exhibits an increased torque to inertia ratio, is lighter and exhibits reduced rotational inertia in comparison to prior art robots having metallic gears or gearboxes.

Two or more axes and/or gearboxes may be arranged serially or may be in serial alignment, e.g. such that at least one gearbox is the payload of at least one other gearbox.

Each of the plurality of gearboxes may be of a common design. Each of the plurality of gearboxes may have or be of a corresponding design. Two or more of the plurality of gearboxes may be of a common design. Two or more of the plurality of gearboxes may have or be of a corresponding design.

Each of the plurality of gearboxes may be of a common or corresponding layout, configuration or arrangement. Two or more of the plurality of gearboxes may be of a common or corresponding layout, configuration or arrangement.

Each of the plurality of gearboxes may be identical. Each of the plurality of gearboxes may have an identical layout, configuration, arrangement or design. Two or more of the plurality of gearboxes may be identical. Two or more of the plurality of gearboxes may have an identical layout, configuration, arrangement or design.

Each of the plurality of gearboxes may be the same size. Each of the plurality of gearboxes may be different sizes. Two or more of the plurality of gearboxes may be the same size.

Two or more of the plurality of gearboxes may be different sizes.

The multi-axis robot may comprise a base and an end effector. A gearbox located at or proximate the base may be larger than a gearbox located at or proximate the end effector.

The robot may have two or more gearboxes, for example three or more gearboxes, four or more gearboxes, five or more gearboxes or six or more gearboxes. The robot may have two gearboxes, three gearboxes, four gearboxes, five gearboxes or six gearboxes.

One or more or each of the plurality of gearboxes may comprise a planetary gear arrangement. The planetary gear arrangement may comprise a sun gear, a planet gear and/or a ring gear. One or more or each of the plurality of gearboxes may comprise an epicyclic gear arrangement. One or more or each of the plurality of gearboxes may comprise a planetary differential arrangement.

One or more of the plurality of gearboxes may be formed entirely of a plastics material. Each of the plurality of gearboxes may be formed entirely of a plastics material.

The sun gear, planet gear and/or ring gear may be formed of a plastics material.

One or more or each of the plurality of gearboxes may comprise a strain wave gear arrangement. The strain wave gear arrangement may comprise a flex spline, wave generator and/or circular spline.

The flex spline, wave generator and/or the circular spline may be formed of a plastics material.

One or more or each of the plurality of gearboxes may comprise a cycloidal gear arrangement. The cycloidal gear arrangement may comprise an orbiting cycloidal gear formed of a plastics material

The plastics material may comprise a plastic falling within the Polyaryletherketone (PAEK) family. PAEKs are particularly advantageous over other plastics, including other thermoplastics, due to their temperature stability. In particular, their temperature stability in the range of 80-120° C., which is the temperature range gearboxes may be exposed to during use.

The plastics material may comprise Polyether ether ketone (PEEK).

One or more or each of the plurality of gearboxes may comprise one or more or a plurality of gears. One or more or each of the plurality of gears may be formed of a plastics material.

One or more or each of the plurality of gears may be injection moulded.

The robot may be a cobot. The robot or cobot may be a serial arm robot. The robot or cobot may be an articulated robot or articulated cobot.

The robot may have two or more axes, for example three or more axes, four or more axes, five or more axes or six or more axes. The robot may have two axes, three axes, four axes, five axes or six axes.

The plastics material may comprise or form part of a composition or composite material. The composition may comprise the plastics material and a filler. The filler may comprise a fibrous filler and/or a non-fibrous filler. The fibrous filler may be continuous or discontinuous.

The fibrous filler may be selected from or comprise inorganic fibrous materials, non-melting organic fibrous materials and/or high-melting organic fibrous materials.

The fibrous filler may be selected from or comprise aramid fibre, glass fibre, carbon fibre, asbestos fibre, silica fibre, alumina fibre, zirconia fibre, boron nitride fibre, silicon nitride fibre, boron fibre, fluorocarbon resin fibre and/or potassium titanate fibre.

The fibrous filler may comprise nanofibers.

The non-fibrous filler may be selected from or comprise mica, silica, talc, alumina, kaolin, calcium sulfate, calcium carbonate, titanium oxide, ferrite, clay, glass powder, zinc oxide, nickel carbonate, iron oxide, quartz powder, magnesium carbonate, fluorocarbon resin, graphite, carbon powder, nanotubes and/or barium sulfate.

The non-fibrous fillers may be introduced into the composition in the form of powder, flat particles, elongated particles, and/or flat and elongated, or flaky particles.

The filler may comprise a reduced wear filler, for example, Polytetrafluoroethylene (PTFE), Polychlorotrifluoroethylene (PCTFE), Perfluoroalkoxy (PFA), Tetrafluorethylene-perfluoropropylene (FEP) and/or Chlorotrifluoroethylene (E-CTFE).

The filler may comprise a reinforcing filler, for example, carbon fibre, glass fibre and/or silica fibre.

The composition may comprise at least 20 wt % of filler, for example at least 30 wt % of filler. The composition may comprise at least 40 wt % of filler, for example at least 50 wt % of filler. The composition may comprise 70 wt % or less of filler, for example 60 wt % or less of filler. The composition may comprise between 40 wt % of filler and 70 wt % of filler, for example between 50 wt % of filler and 60 wt % of filler. This range of filler is advantageous because it increases tensile modulus of the composition and dimensional stability which results in a stiffer and more precise joint meaning that the robot can stop faster and is more responsive to control input.

The composition may further comprise one or more antioxidants, such as a phenolic antioxidant (e.g. Octadecyl-3-(3,5-di-tert.butyl-4-hydroxyphenyl)-propionate), an organic phosphite antioxidant (e.g. tris (2,4-di-tert-butylphenyl) phosphite) and/or a secondary aromatic amine antioxidant.

The composition may form part of a composite material. The composite material may comprise the composition and one or more of light stabilizer(s), heat stabilizer(s), processing aid(s), pigment(s), UV absorber(s), lubricant(s), plasticizer(s), flow modifier(s), flame retardant(s), dye(s), colourant(s), anti-static agent(s), extender(s), metal deactivator(s) and/or conductivity additive(s), e.g. carbon black and/or carbon nanofibril(s). According to another aspect of the invention, there is provided a gearbox for use in a multi-axis robot, e.g. an articulated robot, the gearbox comprising a plurality of gears, wherein at least one of the gears is formed of a plastics material.

The gearbox may be for use in a cobot, e.g. an articulated cobot.

The plurality of gears may describe a planetary gear arrangement. The plurality of gears may comprise a sun gear, a planet gear and/or a ring gear. One or more of the sun gear, planet gear and ring gear may be formed of a plastics material.

The plastics material may comprise a plastic falling within the Polyaryletherketone (PAEK) family.

The plastics material may comprise Polyether ether ketone (PEEK).

The gearbox may be formed entirely of a plastics material.

The gearbox or at least one of the gears may be injection moulded.

According to another aspect of the invention, there is provided a use of a gearbox described above in a robot, a cobot or a serial arm robot.

According to another aspect of the invention, there is provided a gear for use in a gearbox as described above, the gear being formed of a plastics material as described above.

According to another aspect of the invention, there is provided a robot comprising a gearbox, wherein the gearbox has a strain wave gear arrangement and wherein the flex spine has a PAEK-composite laminate structure.

For the avoidance of doubt, any of the features described herein apply equally to any aspect of the invention. For example, the multi-axis robot may comprise any one or more features of the gearbox and/or gears relevant to the multi-axis robot and vice-versa.

Another aspect of the invention provides a computer program element comprising and/or describing and/or defining a three-dimensional design for use with a simulation means or a three-dimensional additive or subtractive manufacturing means or device, e.g. a three-dimensional printer or CNC machine, the three-dimensional design comprising an embodiment of the multi-axis robot or gearbox described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

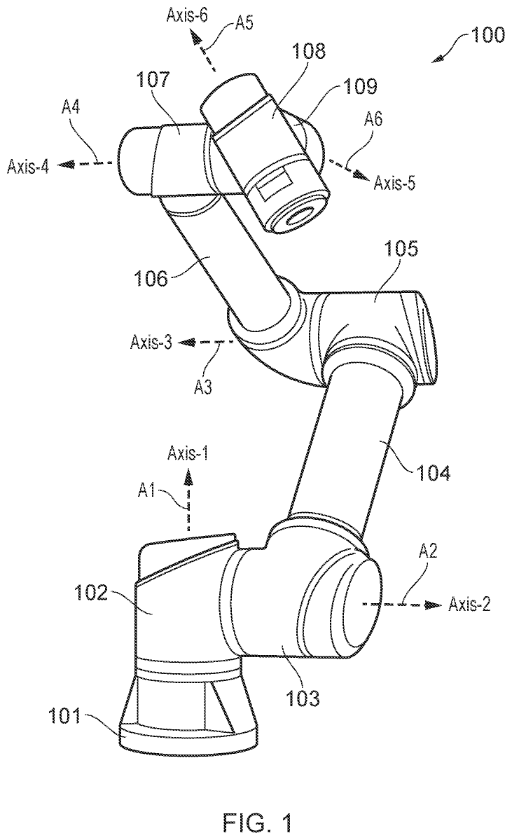

FIG. 1 is an exemplary six-axis serial arm robot;

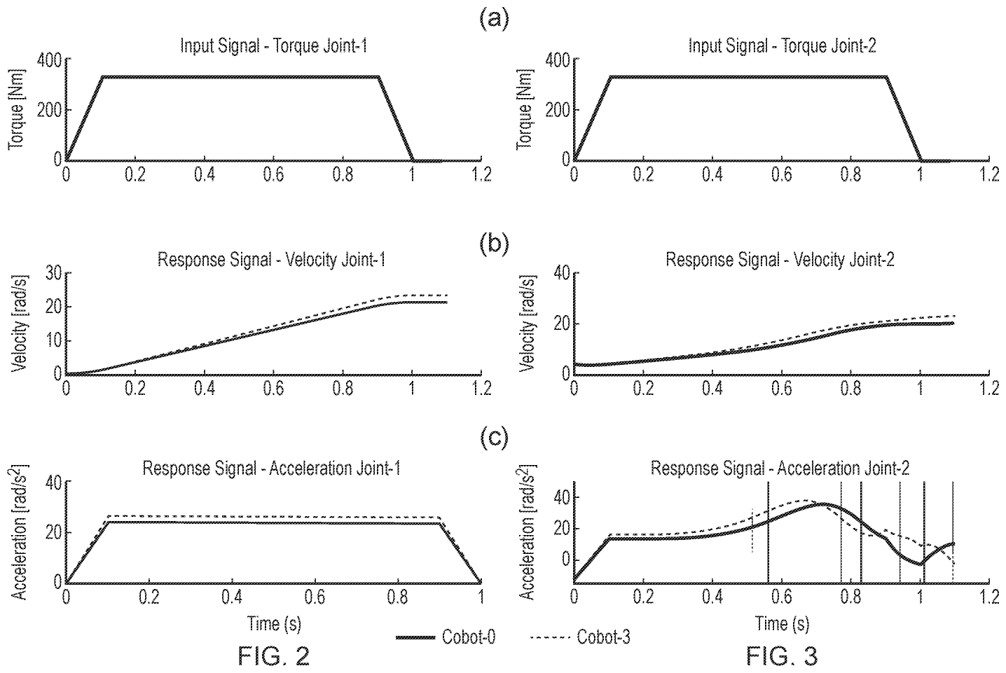

FIG. 2 is a torque response of the first joint of the robot of FIG. 1;

FIG. 3 is a torque response of the second joint of the robot of FIG. 1;

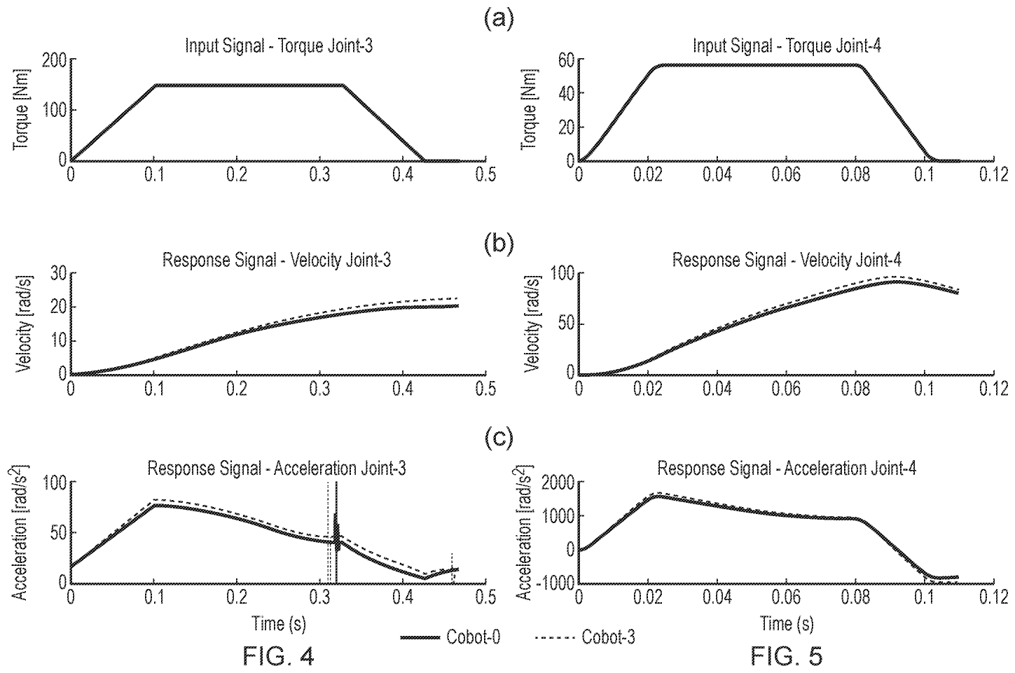

FIG. 4 is a torque response of the third joint of the robot of FIG. 1;

FIG. 5 is a torque response of the fourth joint of the robot of FIG. 1;

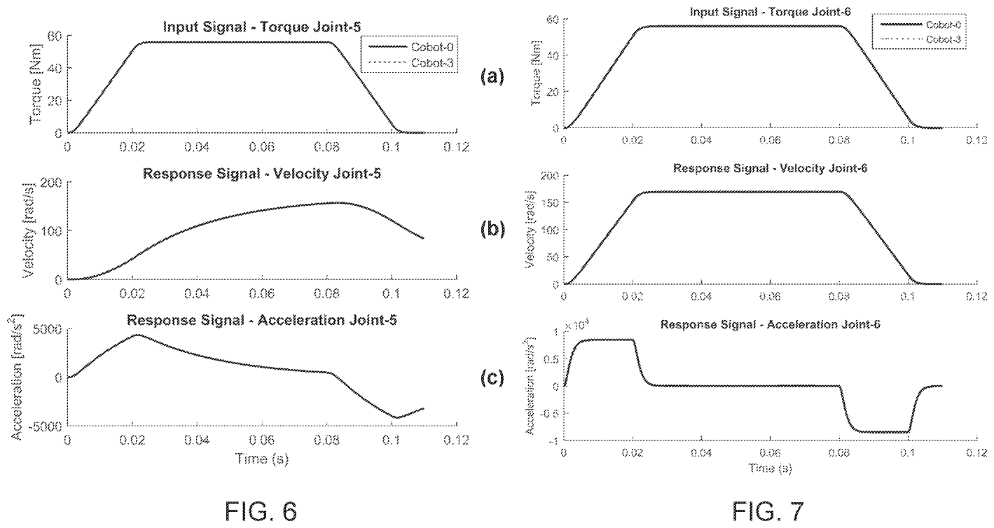

FIG. 6 is a torque response of the fifth joint of the robot of FIG. 1;

FIG. 7 is a torque response of the sixth joint of the robot of FIG. 1;

Referring now to FIG. 1, there is shown six-axis serial arm robot 100 having a base 101. The robot 100 is configured for use as a collaborative robot. A first joint 102 is mounted to the base 101, and is rotatable about a first axis A1. A second joint 103 extends from the first joint 102 and is rotatable about a second axis A2, substantially orthogonal to the first axis A1. A first arm 104 extends from the second joint 103 to a third joint 105. The third joint 105 is rotatable about a third axis A3, substantially parallel to the second axis A2. A second arm 106 extends from the third joint 105 to a fourth joint 107. The fourth joint 107 is rotatable about a fourth axis A4, substantially parallel to the third axis A3. A fifth joint 108 extends from the fourth joint 107 and is rotatable about a fifth axis A5. A sixth joint 109, in the form of a hand or effector, extends from the fifth joint 108 and is rotatable about a sixth axis A6, substantially orthogonal to the fourth axis A4.

Each of the joints 102; 103; 105; 107; 108 and 109 contains a gearbox (not shown) having a planetary gear arrangement and having one or more gears formed of a plastics material. A controller (not shown) is operatively connected with, and configured to control, the joints 102; 103; 105; 107; 108 and 109 so as to move the robot 100.

The planetary gear arrangement has a central sun gear that receives an input torque. The torque applied to the sun gear is transferred to several planetary gears that engage the sun gear. The planetary gears, in turn, drive an outer ring.

In the present example, the first and second joints 102; 103, located towards the base 101, are larger than the third and fourth joints 105; 107. Further, the fifth and sixth joints 108; 109 are smallest, located furthest away from the base 101. The first and second joints 102; 103 are largest in order to support the weight of the robot 100. In the present example, the distance from the base 101, and the size of the respective joint has an effect on the torque response.

In alternative embodiments, several or each of the joints 102; 103; 105; 107; 108 and 109 may be of a common design, wherein the associated gearboxes (not shown) are identical to one another. Accordingly, for example, a gearbox for the sixth joint (and any of the second to fifth joints too) may be constructed identically to one for the first joint (and vice versa). This is possible due to the lightweight nature of the plastics materials from which the gearboxes are formed; a gearbox that is large and robust enough to function at the first joint, handling all of the weight and inertia of the rest of the serial arm robot is also light and nimble enough to be used at the sixth joint without significantly adversely affecting the weight and inertia of the robot arm in comparison to a dedicated gearbox for that application. Thus, all joints of a multi-axis robot—particularly a serial arm robot—can use a common type of gearbox, meaning a reduced amount of parts need to be made and stocked, which saves on manufacturing and servicing costs.

Referring now to FIGS. 2 to 7, there is shown a torque response for each of the joints 102; 103; 105; 107; 108 and 109 respectively. Each of FIGS. 2 to 7 contains three graphs, the first graph labelled ‘(a)’ showing the ‘input signal’, i.e. the torque input applied to the respective joint via the gearbox. In the first graph, the y-axis represents the torque input in Newton metres (Nm) and the x-axis represents time in seconds(s). The second graph labelled ‘(b)’ shows the velocity response of the respective joint to the torque input. In the second graph, the y-axis represents the velocity response of the respective joint in radians per second (rad/s) and the x-axis represents time in seconds(s). The third of the three graphs labelled ‘(c)’ shows the acceleration response of the respective joint to the torque input. In the third graph, the y-axis represents the acceleration response of the respective joint in radians per second squared (rad/s²) and the x-axis represents time in seconds(s).

Further, each of the second and third graphs (velocity response and acceleration response) has a solid line and a dashed line. The solid line shows the response of a joint of a six-axis serial arm robot 100 as per FIG. 1 having metallic gears. The dashed line shows the response of a joint of a six-axis serial arm robot 100 as per FIG. 1 having gears formed of a plastics material.

Referring now to FIG. 2, there is shown the torque response of the first joint 102. A torque input is applied, increasing from zero Newton metres to approximately 300 Newton metres at 0.1 seconds. The input is maintained for 0.8 seconds before decreasing to zero at 1 second. It is evident from the second graph of FIG. 2 that in comparison to a robot with metal gears, the velocity response of the first joint 102 is greater in a robot having gears formed of a plastics material. This is particularly evident from 0.4 seconds onwards. The increase in velocity is shown by the dashed line lying above the solid line from 0.4 seconds onwards.

The third graph shows the acceleration response of the first joint 102 following a similar profile to the torque input. It is clear that a greater acceleration of the first joint 102 is obtained in the case of the robot having gears formed of a plastics material (dashed line). Therefore, by providing a gearbox with gears formed of a plastics material, the responsiveness of the first joint 102 to a torque input is increased.

Referring now to FIG. 3, there is shown the torque response of the second joint 103. A torque input is applied, which is the same as the torque input applied to the first joint 102, discussed above in respect of FIG. 2. It is evident from the second graph of FIG. 3 that in comparison to a robot with metal gears, the velocity response of the second joint 103 is greater in a robot having gears formed of a plastics material. This is particularly evident from 0.4 seconds onwards. The increase in velocity is shown by the dashed line lying above the solid line from 0.4 seconds onwards.

From the third graph of FIG. 3, it is clear that a greater acceleration of the second joint 103 is obtained in the case of the robot having gears formed of a plastics material (dashed line).

Referring now to FIGS. 4 and 5, the increase in velocity and acceleration response of the third and fourth joints 105; 107 respectively is shown from the second and third graphs. As the third and fourth joints 105; 107 are smaller than the first and second joints 102; 103, and support less weight, the improvement in velocity and acceleration response in the case of plastics gears is not as great as seen in the first and second joints 102; 103.

Referring now to FIGS. 6 and 7, the increase in velocity and acceleration response of the fifth and sixth joints 108; 109 respectively is shown from the second and third graphs. As the fifth and sixth joints 108; 109 are the smallest of the robot 100 as per FIG. 1, are furthest away from the base 101, and support the least weight, the improvement in velocity and acceleration response in the case of plastics gears is not as great as in the first to fourth joints 102; 103; 105; 107.

However, FIGS. 2 to 7 show that the velocity and acceleration response of a joint is increased when the gearbox of said joint has one or more gears formed of a plastics material. In the case of a robot 100 as per FIG. 1, the improvement is most notable in those joints closest to the base 101, and which support the most weight.

It will be appreciated by those skilled in the art that several variations to the aforementioned embodiments are envisaged without departing from the scope of the invention. For example, the robot 100 need not have six joints, but instead may have two, three, four, five or any suitable number of joints.

Further, it is described that each of the gearboxes has a planetary gear arrangement. This need not be the case. One or more of the joints 102; 103; 105; 107; 108 and 109 containing a gearbox (not shown) may have a strain wave gear arrangement or a cycloidal gear arrangement.

A strain wave gear arrangement utilises a flexible spline that has external teeth. The flexible spline is deformed by an internal rotating wave generator, forcing the external teeth of the flexible spline to engage internal teeth of a rigid outer spline. The flexible spline has fewer teeth than the rigid outer spline, forcing the flexible spline to rotate as it is deformed by the wave generator.

A cycloidal gear arrangement utilises an eccentrically mounted input shaft which, in turn, rotates a cycloidal disc. The cycloidal disc has a plurality of holes that receive output roller pins. The output roller pins are connected to an output shaft, and are smaller than the holes in the cycloidal disc. The cycloidal disk is configured to transmit rotation from the input shaft to the output shaft.

It will also be appreciated by those skilled in the art that any number of combinations of the aforementioned features and/or those shown in the appended drawings provide clear advantages over the prior art and are therefore within the scope of the invention described herein.

1. A multi-axis robot comprising a plurality of gearboxes, wherein each of the plurality of gearboxes is configured to operate on a respective robot axis and comprises one or more gears formed of a plastics material.

2. A multi-axis robot according to claim 1, wherein each of the plurality of gearboxes is of a common design.

3. A multi-axis robot according to claim 2, wherein each of the plurality of gearboxes is identical.

4. A multi-axis robot according to claim 1, wherein one or more or each of the plurality of gearboxes comprises a planetary gear arrangement, a strain wave gear arrangement and/or a cycloidal gear arrangement.

5. A multi-axis robot according to claim 1, wherein each of the plurality of gearboxes is formed entirely of a plastics material.

6. A multi-axis robot according to claim 1, wherein the plastics material comprises a plastic falling within the Polyaryletherketone (PAEK) family.

7. A multi-axis robot according to claim 6, wherein the plastics material comprises Polyether ether ketone (PEEK).

8. A multi-axis robot according to claim 1, wherein the plastics material forms part of a composite material, the composite material further comprising a filler.

9. A multi-axis robot according to claim 8, wherein composite material comprises at least 20 wt % of filler.

10. A multi-axis robot according to claim 8, wherein the filler is a reinforcing filler comprising carbon fibre, glass fibre and/or silica fibre.

11. A multi-axis robot according to claim 8, wherein the filler is a reduced wear filler comprising Polytetrafluoroethylene (PTFE), Polychlorotrifluoroethylene (PCTFE), Perfluoroalkoxy (PFA), Tetrafluorethylene-perfluoropropylene (FEP) and/or Chlorotrifluoroethylene (E-CTFE).

12. A multi-axis robot according to claim 1, wherein each of the plurality of gearboxes comprises a plurality of gears.

13. A multi-axis robot according to claim 1, wherein the robot is a cobot or a serial arm robot.

14. (canceled)

15. A multi-axis robot according to claim 1, wherein the robot has 2 or more axes.

16. A gearbox comprising a plurality of gears, wherein at least one or the gears is formed of a plastics material.

17. A gearbox according to claim 16, wherein the plurality of gears describe a planetary gear arrangement.

18. A gearbox according to claim 16, wherein the plastics material comprises Polyether ether ketone (PEEK).

19. A gearbox according to claim 16, formed entirely of a plastics material.

20. A robot, a cobot or a serial arm robot comprising a gearbox according to claim 16.

21. (canceled)

22. A robot comprising a gearbox, wherein the gearbox has a strain wave gear arrangement and wherein the flex spine is a PAEK-composite laminate structure.
